(19) United States
(12) Patent Application Publication
(10) Pub. No.: US 2004/0096003 A1
(43) Pub. Date: May 20, 2004

(54) Device for receiving digital radio signals

(76) Inventor: Bernhard Horn, Forchheim (DE)

Correspondence Address: Quarles & Brady, 411 E Wisconsin Avenue, Milwaukee, WI, 53202-4497, US

(21) Appl. No.: 10/470,794

(22) PCT Filed: Jan. 24, 2002
(86) PCT No.: PCT/EP02/00684

(30) Foreign Application Priority Data
Feb. 1, 2001 (DE) 101 04 441.0

(51) Int. Cl. H04N 7/12

(52) U.S. Cl. 375/240.28; 375/240.26

(57) ABSTRACT

The invention relates to a device for receiving digital radio signals. Said device comprises a digital receiver with a tuner and a demodulator that is connected to the tuner, in addition to a first microcomputer. The demodulator and the first microcomputer are connected to an add-on module via a device interface of the digital receiver. Said module has second microcomputer and a signal processing unit that is controlled by the second microcomputer, the output of said unit being connected to the device interface. The inventive device further comprises a packet start detector, which prevents image, audio or data interference during the changeover of operating modes.

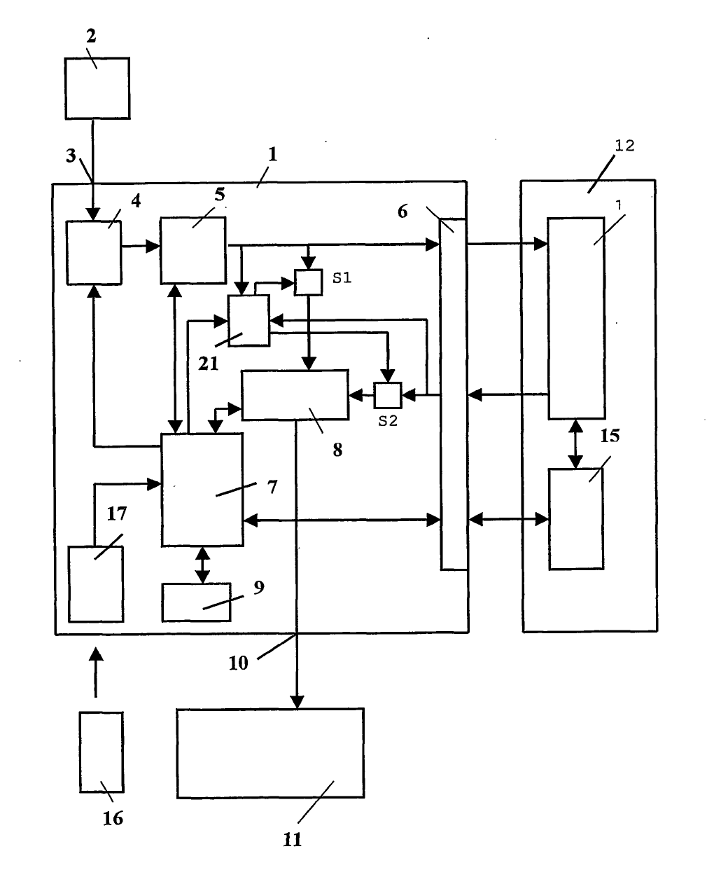

### DESCRIPTION

The invention concerns a device for reception of digital radio signals.

So-called settop boxes provided for reception of analog and/or digital satellite radio signals are already known. Such settop boxes are ordinarily made in the form of an independent device and connected between the external units of a satellite receiver and an ordinary television receiver. In such a settop box conversion of signals derived from the external unit of the satellite receiver to signals that are fed to an ordinary television receiver via its HF input or its Euro-AV socket occurs.

It is already known to design the assemblies of a settop box in the form of a module and to integrate this module in the housing of a television receiver.

Digital radio signals transmitted via radio satellites can contain digital teletext data and other digital data in addition to digital audio and video data, which can be received by digital receiver. It is also desirable to have access to internet data and/or other data services by means of a digital receiver. If one wants to be able to receive and process a variety of digital data by means of a single digital receiver, one must tolerate that the manufacturing and therefore final selling prices for digital receivers are high. Such digital receivers are also complicated in design so that high requirements are imposed on equipment developers. Under practical conditions a variety of the functions of the device will never be used by most buyers of such digital receivers. However, these purchasers must also pay the mentioned high prices for the digital receiver.

These shortcomings are avoided in a device for reception of digital radio signals as described in DE 10007710.2. This known device, which corresponds to the preamble of claim 1, has an additional module that is connected to a digital receiver via a device interface. The additional module is provided with a signal processing unit to which an MPEG transport stream made available on the input side by a digital receiver and derived from the received signal is fed. The output signal of the signal processing unit of the additional module goes back to the digital receiver via the device interface and is further processed there.

The underlying task of the invention is to show a way to improve the device described in DE 10007710.2.

This task is solved by a device with the features stated in claim 1. Advantageous embodiments and modifications of the invention are stated in the dependent claims.

The advantages of the invention consist in particular of the fact that, in the case of mode switching from a direct mode, in which the MPEG transport stream is processed by shunting the additional module, to a bypass mode in which the MPEG transport stream is processed in the additional module, or vice-versa, no switching disturbances occur. Additional advantageous properties of the invention are apparent from their explanation with reference to the FIGURE which shows a block diagram of the device for reception of digital radio signals.

The depicted device has a satellite receiving antenna 2, whose output signals are fed to a digital receiver 1 via its input terminal 3. For playback of signal received by the digital receiver, a television receiver 11 connected to the output 10 of the digital receiver is provided. The digital receiver 1 is also connected to an additional module 12 via a device interface 6. The depicted device can be operated in different modes.

In a first mode, signals derived from the satellite antenna 2 are fed to the digital receiver 1, which is a settop box, via its input terminal 3. From there they are fed to a demodulator 5 via tuner 4. This furnishes digital data at its output in the form of an MPEG transport stream. This transport stream contains a multiplex of several services, in which the signals are transmitted in the form of packets. A service can contain one or more television programs, one or more radio programs, additional data for the radio and television programs, like teletext data, multilanguage audio data, a program guide and subtitle data. A service can also contain data services or programs in the EDP sense.

This MPEG transport stream is fed to a single processing unit 8 via a switch S1 in which selection of the desired service or a data substream corresponding to the service occurs. Conversion of the selected subdata stream into signals that are fed to the connected television receiver via output 10 where they are displayed on the screen also occurs in signal processing unit 8.

Control of tuner 4, demodulator 5 and signal processing unit 8 occurs by control signals that are generated in the microcomputer 7 of the settop box. The microcomputer 7 generates the mentioned control signal as a function of operating commands that are entered by means of an operating unit of the settop box having a remote control 16 and a remote receiver 17.

In another mode of the depicted device, the signals derived from the satellite antenna 2 are fed to the digital receiver 1, which is a settop box, via its input terminal 3. From there they are fed to demodulator 5 via tuner 4. This furnishes digital data as output in the form of an MPEG transport stream, which, as already mentioned above, has a multiplex of several services. One of these services contains coded image signals.

The settop box 1 itself is not capable of decoding such coated image signals. Consequently, the MPEG transport stream in this case is fed to the additional module 12 via the device interface 6. This has a signal processing unit 14 in which a video signal decoder is provided.

For separation of the subdata stream corresponding to the coded video signals, the corresponding identifications of the subdata stream must be sent to the additional module 12 so that the additional module 12 can automatically extract and decode this subdata stream. The identifications can be stipulated directly or indirectly by commands of the operating unit 16, 17 of the settop box and fed to the microcomputer 15 of the additional module via the microcomputer 7 and interface 6.

This generates a control signal for the signal processing unit 14, which specifies the subdata stream to be decoded.

The signals decoded by the signal processing unit 14 are fed to the signal processing unit 8 of the settop box 1 via the device interface 6 and a switch S2.

The settop box 1 or the television receiver 11 connected to it has a transmitter or program memory in which characteristic data for a number of television programs are stored. These data include information on receiving frequency, identification of the subdata stream corresponding to the television program, the type of any coding, etc.

If switching to a desired television program occurs by means of keys of the remote control 16, then the microcomputer 7 reads out from the mentioned transmitter memory the characteristic data pertaining to the desired television program and uses it to control tuner 4, demodulator 5, a packet start detector 21 and the signal processing unit 8. The microcomputer 7 also transmits certain characteristic data via the interface 6 to microcomputer 15 of the additional module 12. The identification of the corresponding subdata stream and the type of possible coding are among the characteristic data transmitted to the microcomputer 15 via interface 6.

Thus, for example, a program switch occurs from a first television program that is not transmitted in coded fashion, to a second television program that is transmitted in coded fashion, then a switch must be made from a mode in which the MPEG data stream is sent directly to the signal processing unit 8, bypassing the additional module 12 via switch S1 (direct mode), to a mode in which the MPEG data stream is sent to the signal processing unit 8 via additional module 12 and switch S2 (bypass mode).

In order to avoid or at least reduce disturbances in the playback image during the switching process, the packet start detector 21 and switches S1 and S2 are provided in the depicted practical example.

The entry of a corresponding switch command activated by means of a remote control is registered by microcomputer 7. Microcomputer 7 recognizes for the characteristic data read out from the transmitter memory 9 that a switch from direct mode to bypass mode has been carried out and sends a corresponding control signal to the packet start detector 21. The packet start detector 21 recognizes the presence of a packet start by evaluation of the decoded signal delivered by the additional module 12 with reference to the packet start indicator contained in the data stream and releases the signal path between the additional module 12 and the signal processing circuit 8 by closure of switch S2 only on occurrence of the mentioned packet start indicator. At the same time, the packet start detector 21 opens switch S1, which has been closed to that point.

Because of such packet-synchronous switching to a new data path, a situation is avoided in which switching occurs during the duration of a packet, which will be connected with disorders in the playback image and time delays until a new image is obtained. The data block 21 also contains a transmission frame start detector in addition to the packet start detector. A complete image of the desired television program is distributed in several packets in the MPEG data stream, which are transmitted in time multiplex with the packets of other television programs and additional services. By means of the mentioned transmission frame start detector, the beginning of a new image is detected by evaluation of a transmission frame start bit contained in the data stream and the aforementioned switching process is only released when an output signal is available both to the packet start detector and the transmission frame start detector in the sense of an AND link. This can be accomplished, for example, using a simple logic circuit having flip-flops.

On the other hand, if a program switch occurs from the first television program that is transmitted in coded fashion to a second television program that is not transmitted in coded fashion then a switch must be made from a mode in which the MPEG data stream is sent to the signal processing unit 8 via the additional module 12 and switch S2 (bypass mode) to another mode in which the MPEG data stream is sent directly to the signal processing unit 8 via switch S1, bypassing the additional module 12 (direct mode).

In order to avoid or at least reduce disturbances in the playback image during the switching process, the packet start detector 21 and switches S1 and S2 are provided in the depicted example.

The entry of the corresponding switching command activated by means of the remote control is registered by microcomputer 7. Microcomputer 7 recognizes the characteristic data read out from the transmitter memory 9 that a switch from bypass mode to direct mode has occurred and sends a corresponding control signal to the packet start detector 21. The packet start detector 21 recognizes the presence of a packet start with reference to the packet start indicator contained in the MPEG transport stream by evaluation of the coded signal furnished by the demodulator 5, and releases the signal passed between the demodulator 5 and the signal processing circuit 8 by closing switch S1 only on occurrence of the mentioned packet start indicator. At the same time the packet start detector 21 opens switch S2, which has been closed to that point.

Through such packet-synchronous switching to a new data path, a situation is avoided in which switching occurs during the duration of a packet, which would be connected with disturbances in the playback image and time delays until a new image is received.

A transmission frame start detector is also contained in data block 21 in addition to the packet start detector. A full image of a desired television program is distributed in the MPEG data stream for several packets that are transmitted in time multiplex with the packets of other television programs and other services. By means of the mentioned transmission frame detector, the beginning of a new image is detected by evaluation of a transmission frame start indicator contained in the data stream and the aforementioned switching process is only released if an output signal is available to the packet start detector and the transmission frame start detector in the sense of an AND link. This can be accomplished using a simple logic circuit that has flip-flops.

As an alternative to the reception of video signals, tone signals, data signals and other services can be received and played back by means of the device depicted in the FIGURE. The beginning of a new transmission frame is then the start of a new tone signal unit or the start of a new data signal unit, which is also reported here by transmission of a transmission frame start indicator in the MPEG transport stream.

The described additional module 12 is preferably a flat, diskette-like component that can be inserted through an entry slit in the settop box and in the inserted state is in contact with the device interface 6. Because of this it is readily possible to use additional modules in flexible fashion with different settop boxes.

A digital receiver according to the invention need not be a settop box. The digital receiver can also be a digital television receiver that has the depicted device interface 6 through which an additional module can be connected to the receiver.

1. Device for reception of digital radio signals with
a digital receiver which is a receiving unit having a tuner and a demodulator and
has a first microcomputer, in which
data corresponding to an MPEG transport stream are present at the output of the demodulator and in which
the demodulator is connected to a signal processing unit and to an additional module via the device interface of the digital receiver and in which
the additional module has a second signal processing unit, whose output is connected to the first signal processing unit via the device interface,
characterized by the fact
that it has a packet start detector (21) connected to the output of the demodulator (5),
that a control signal can be sent to the packet start detector (21) from the first microcomputer (7) and
that the packet start detector (21) in response to the control signal releases a signal path to the first signal processing (8) only on occurrence of a packet start indicator.

2. A device according to claim 1, characterized by the fact that the first microcomputer (7) generates the control signal after entry of a program switching command.

3. A device according to claim 1 or 2, characterized by the fact that the first microcomputer (7) generates the control signal after switching of the digital receiver from the first mode to the second mode or vice-versa, in which the MPEG transport stream present at the output of the demodulator (5) in the first mode is fed directly to the first signal processing unit (8), bypassing the additional module (12), and the MPEG transport stream present at the output of the demodulator (5) in the second mode is fed to the first signal processing unit (8) via the additional module (12).

4. A device according to one of the preceding claims, characterized by the fact that it has a first switch (S1) between the demodulator (5) and the first signal processing unit (8) whose control input is connected to an output of the packet start detector (21).

5. A device according to one of the preceding claims, characterized by the fact that it has a second switch (S2) between the second signal processing unit (14) and the first signal processing unit (8) whose control input is connected to an output of the packet start detector (21).

6. A device according to claim 5, characterized by the fact that the packet start detector (21) is connected to the output of the second signal processing circuit (14).

7. A device according to one of the preceding claims, characterized by the fact that the packet start detector (21) is a component of the digital receiver (1).

8. A device according to one of the claims 1 to 6, characterized by the fact that the packet start detector (21) is a component of the additional module (12).

9. A device according to one of the preceding claims, characterized by the fact that it also has a transmission frame start detector (21) connected to the output of the demodulator (5), which in,response to the control signal releases the signal path through the first signal processing unit (8) only on occurrence of a transmission frame start indicator.

10. A device according to claim 9, characterized by the fact that a transmission frame start corresponds to the start of a new image, a new tone signal unit or a data signal unit.

11. A device according to one of the preceding claims, characterized by the fact that the digital receiver is a settop box or a digital television receiver.
